(19) United States
(12) Patent Application Publication
(10) Pub. No.: US 2013/0298573 A1
(43) Pub. Date: Nov. 14, 2013

(54) APPARATUS FOR COMPENSATING LONGITUDINAL CHANGES IN SUPERCONDUCTIVE CABLES

(71) Applicant: NEXANS, Paris (FR)

(72) Inventors: Mark Stemmle, Hannover (DE); Erik Marzahn, Langenhagen (DE)

(73) Assignee: NEXANS, Paris (FR)

(21) Appl. No.: 13/666,013

(22) Filed: Nov. 1, 2012

(30) Foreign Application Priority Data
Nov. 3, 2011 (EM) 11 306 411.7

(51) Int. Cl. F17C 13/02; H01B 12/16

(52) U.S. Cl. CPC F17C 13/02; H01B 12/16
USPC 62/51.1; 505/163

(57) ABSTRACT

An apparatus for guiding a cryostat for the compensation of thermal contraction, particularly of a cryostat, which contains along its inner volume a cable core with a superconductor, which particularly preferred is secured stationary to the ends of the cryostat, wherein the cryostat has in a section an arc-shape configuration and is movably guided essentially exclusively perpendicular to its longitudinal axis.

### RELATED APPLICATION

This application claims the benefit of priority from European Patent Application No. 11 306 411.7, filed on Nov. 3, 2011, the entirety of which is incorporated by reference.

### BACKGROUND

1. Field of the Invention

The present invention relates to an apparatus for compensating and/or monitoring the movement of a cable, which includes a cryostat to be cooled, during its thermal contraction or expansion, as well as a method for monitoring the movement of the cryostat during its contraction or expansion with the use of the apparatus.

The apparatus is particularly suitable for monitoring the movement occurring during expansion or contraction of a cryostat, and for avoiding or absorbing the forces acting axially on the cryostat, and preferably reduces forces which occur during thermal conditioning of the cryostat between the cryostat and a cable core arranged therein.

The cryostat includes preferably two concentrically arranged undulated steel pipes which form a ring-shaped intermediate space therebetween, which includes a vacuum insulation. The device permits the ends of a cable core, which is arranged along the cryostat, to be fixed stationary at the respective ends of the cryostat.

The apparatus according to the invention may include at least one cable with a cryostat containing at least one cable core, or optionally two or more cryostats arranged essentially parallel, wherein, for example, the cryostats contain a single-phase or multiple-phase superconductive cable core.

The method according to the invention provides that, by filling its internal volume, the cryostat is defined by the inner wall of its concentric walls, is cooled with cooling agent from room temperature to the temperature of the cooling agent, and is optionally thermally conditioned by the temperature of the cooling agent by draining the cooling agent. Liquid nitrogen is especially preferred as cooling agent, and less preferred is liquid, helium.

### DESCRIPTION OF THE RELATED ART

EP 1617537 describes a superconductive cable in which the superconductive cable core is continuously connected to a normal conductor, which is guided by an end piece that is longitudinally slidable.

EP 1480231 describes the production of an excess length of the superconductive cable core in a cryostat by connecting the ends of the cable core to the cryostat in the wound-up state.

### OBJECTS AND SUMMARY

It is the object of the invention to make available an alternative device or a method for monitoring the movement of the cryostat during its thermal conditioning, particularly to the temperature of the cooling agent. A preferred object is to make available a device which absorbs the movement occurring during filling a cooling agent into the cryostat in such a way that an additional compensation of a relative movement between. cable core and cryostat is not necessary, but the cable core may be fixed so as to be stationary in end closures of the cryostat.

The invention meets this object with the features of the Claims, in particular with a device for guiding a cryostat for use in the compensation of the thermal contraction, particularly of a cryostat which contains along its internal volume a cable core with a superconductor which, in accordance with a particularly preferred feature, is fixed so as to be stationary at the ends of the cryostat, wherein the cryostat has, in a section thereof, an arc-shaped configuration and is movably guided in this section by means of a device exclusively perpendicularly relative to its longitudinal axis. The cryostat is connected to the apparatus by means of a support.

In its section having the arc-shaped configuration, the cryostat preferably has a sleeve which is secured to the support. A sleeve may optionally form cylindrical sections of the concentric walls of the cryostat, while the adjacent sections of the cryostat have ring shaped or helically shaped undulated walls. The cable core is preferably secured in the area of the sleeve to the cryostat or to the sleeve, so that the cable core is fixed in the area of the sleeve against a movement along the longitudinal axis of the cryostat in particular in this embodiment, a relative movement of the cable core within the cryostat is minimized particularly effectively, while the movements of the cryostat occurring during contraction of the cryostat are absorbed by the device.

The apparatus is distinguished by a support in which the cryostat is fixed and the support is guided essentially exclusively movably perpendicular to the longitudinal axis of the cryostat, in particular in the section of the cryostat having the exclusively radially arc-shaped configuration. In a preferred embodiment, the cryostat, by means of the support, is movably guided essentially exclusively perpendicular to its longitudinal axis by movably guiding the support of the guiding device to at least one rail, preferably to two parallel rails, which extend perpendicularly of the longitudinal axis of the cryostat or in the expanded state of the cryostat, particularly when the cryostat is free of cooling agent, radially to its section having the arc-shaped configuration.

Alternatively, the device has an arm movable essentially exclusively in a plane extending perpendicularly to the longitudinal axis of the cryostat, wherein the arm is particularly movable exclusively linearly. Such an arm may have or may consist of, for example, a knee joint, a scissor lattice and/or a parallel displacement device, whose pivot axes are arranged preferably parallel to the longitudinal axis of the cryostat and/or tangentially to the arc-shaped configuration of the cryostat. Such an arm is mounted so as to be stationary, for example, at its end located opposite the support. The stationary bearing of the arm can be arranged above, below, laterally, or at an angle relative to the perpendicular of the cryostat, wherein preferably also the stationary bearing of the arm has a pivoting axis extending parallel to the longitudinal axis of the cryostat or tangentially to the arc-shaped configuration of the cryostat. Preferably, the device has at least two parallel arms whose pivoting axes may be arranged coaxially. Alternatively, at least two arms may extend in parallel planes of the support, for example, at an angle relative to each other, for example, V-shaped or located opposite the support.

The apparatus according to the invention of the device for guiding the cryostat in its section with the arc-shaped configuration essentially exclusively perpendicular to its longitudinal axis or radially relative to the arc-shaped configuration, causes, upon movement of the cryostat by thermal contraction or expansion in its longitudinal axis, a controlled guidance of the movement of the cryostat which, on the one hand, permits an excess length of the cryostat at ambient temperature relative to its length in the contracted state after filling in the cooling agent, and reduces and/or absorbs any axial forces which extend along the cryostat and/or along a cable core arranged in the cryostat in addition the apparatus has the advantage that, with a relatively simple construction, a reliable reduction or avoidance of forces acting along the cryostat or the cable core as a result of thermal contraction or expansion due to an ability of the support to be displaced essentially exclusively perpendicularly of the longitudinal axis of the cryostat, or radially relative to the arc-shaped configuration of the cryostat due to the slidability of the support guided essentially exclusively, in which the cryostat is fixed and is particularly secured at that location, especially against axial movement.

In the method according to the invention, the cryostat, fixed stationary to the support of the apparatus, in which preferably a superconductive cable core is contained whose ends, secured against longitudinal displacement, are connected to the ends of the cryostat, wherein the support is guided so as to be movable essentially exclusively perpendicular of the longitudinal axis of the cryostat. The support is preferably movably guided essentially exclusively perpendicular to the longitudinal axis of the cryostat by being slidably guided on rails arranged perpendicularly of the longitudinal axis of the cryostat, for example, by means of wheels whose axes of rotation are arranged essentially parallel to the longitudinal axis of the cryostat. Upon contraction or expansion of the cryostat along the longitudinal axis thereof, which, when cooling agent is filled into the inner volume of the cryostat, or when the cryostat is heated by the temperature of the cooling agent to ambient temperature, the section of the cryostat fixed to the guided support moves essentially exclusively perpendicular to its longitudinal axis, so that any forces acting along the cryostat are reduced or essentially avoided, wherein preferably any forces acting along the cryostat are absorbed by the apparatus.

When using the preferred apparatus in which the support is movably guided by means of wheels essentially perpendicularly of the longitudinal axis of the cryostat, or radially relative to the arc-shaped configuration of the cryostat, the support moves along the rails as the cryostat contracts or expands. In the alternative embodiment, the support moves essentially perpendicularly of the longitudinal axis of the cryostat by swinging the articulated members of an arm which is movable essentially exclusively perpendicular to the longitudinal axis of the cryostat, so that, for example, the support is pivoted in a plane extending parallel to the longitudinal axis of the cryostat or is subjected to parallel displacement.

The guiding device is preferably equipped for the linear guidance of the support perpendicular to the longitudinal axis of the cryostat, or radially relative to the arc-shaped configuration of the cryostat, optionally for guiding the support in a line aligned horizontally or vertically, or in a line inclined relative to the horizontal, for example, of 10° to relative to the horizontal. In the embodiment in which the guiding device of the apparatus includes rails for guiding the support, the support can be arranged above or below the rails, wherein wheels guided on the rails are mounted in a support, while the rails are arranged so as to be stationary, or the rails are fastened to the support while the wheels guided on the rails are arranged stationary. Correspondingly, the wheels guided on the rails may be mounted in the support and may be guided or rails arranged underneath the wheels, may be suspended above the rails. Optionally, the rails may be concave or convex, for example, bent around a center axis extending parallel to the longitudinal axis of the cryostat; the rails preferably extend in a plane.

The guiding device preferably includes two parallel rails on which the support is guided.

### BRIEF DESCRIPTION OF THE DRAWINGS

The invention will now be explained in more detail with the aid of the Figures which schematically show in

FIG. 1, a preferred embodiment of the apparatus prior to filling cooling agent into the interior volume of the cryostat,

FIG. 2, the embodiment of FIG. 1 in the state filled with cooling agent,

FIG. 3, an embodiment with three cryostats extending parallel to each other prior to filling in the cooling agent,

FIG. 4, the embodiment of FIG. 3 after filling in the cooling agent,

FIG. 5, an embodiment of an arm for guiding the cryostat,

FIG. 6, another embodiment of an arm for guiding the cryostat, and

FIG. 7, a further embodiment of an arm for guiding the cryostat.

### DETAILED DESCRIPTION

In the Figures, the same reference numerals refer to the same functionally equivalent elements.

FIG. 1 shows a cryostat 1 of a superconductive cable which contains a superconductive cable core in its inner volume. The cryostat 1 is arranged in a section with an arc-shaped configuration in which a support 2 is fastened to the cryostat 1. In accordance with the preferred embodiment, the cryostat 1 has in the area of the support 2 a sleeve 3, which optionally has cylindrical walls which continue the concentrically undulated walls of the cryostat 1. The support 2 is movably guided on two parallel rails 4 which are arranged perpendicular to the longitudinal axis of the cryostat 1.

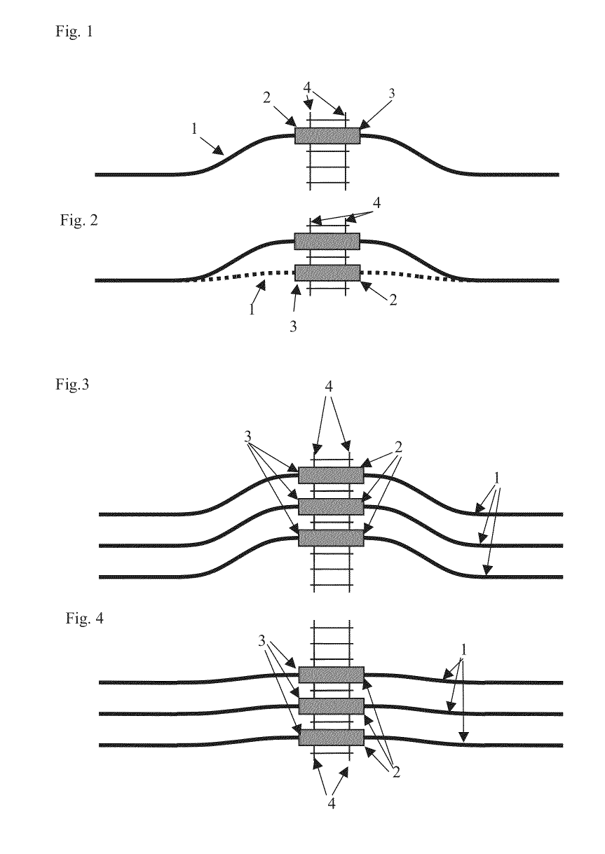

FIG. 1 shows the state of the apparatus in which the cryostat 1 has not yet been provided with cooling agent, so that the cryostat 1 still has room temperature. This state is also called the expanded state, while FIG. 2 shows the state of the cryostat which is assumed after filling in cooling agent. The contraction of the cryostat 1 along its longitudinal axis is transposed by the connection of the support 2 to the cryostat 1 through the guidance of the support 2 along the rails 4 into a movement of the support 2, which is directed perpendicularly to the longitudinal axis of the cryostat 1, so that the cryostat 1 assumes the position shown in broken lines in the contracted state. The rails 4 may be arranged horizontally or vertically.

The embodiment illustrated in FIGS. 1 and 2 is particularly suitable for superconductive cables in which at least two phase conductors are arranged. in the cryostat 1, particularly two or stranded phase conductors which are optionally in parallel or with long lay contained within the cable cores arranged within the cryostat 1, or, for example, concentric on a common cable core.

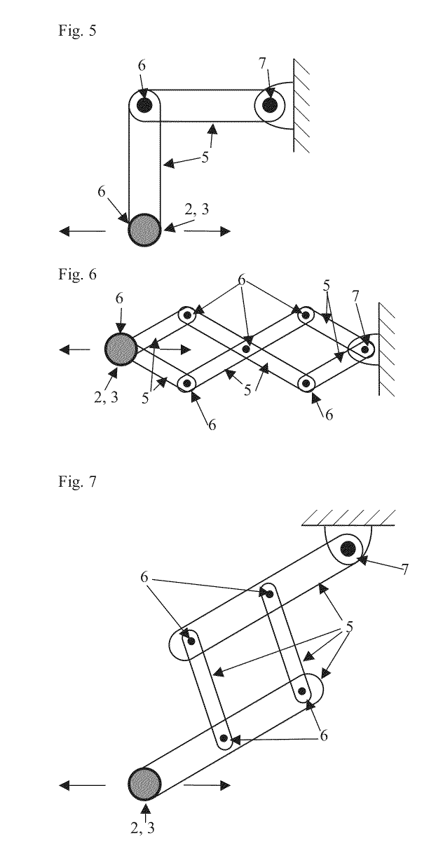

FIGS. 3 and 4 show the apparatus for three cryostats 1 which extend essentially parallel, and which each contain, for example, a single-phase superconductive cable core. The cryostats 1 are each secured in a support 2, particularly in a section in which they are arranged in an arc-shaped configuration and each have a sleeve 3. Each of the supports 2 is movably guided on rails 4 essentially perpendicularly to the longitudinal axes of the cryostats 1, or radially relative to the arc-shaped configuration of the cryostats 1.

FIG. 3 shows the state of the cryostats 1, prior to filling in the cooling agent, so that the cryostats 1 are present in an expanded state and form an arc-shaped configuration with a radius which is greater than in the state shown in FIG. 4, in which they are present in a contracted state after filling in cooling agent. FIG. 4 shows that the support 2 is displaced essentially perpendicular to the longitudinal axis of the cryostat on the rails 4.

FIGS. 5 to 7 show generally embodiments of the apparatus in which the movement of the cryostat is guided essentially exclusively perpendicular to the longitudinal axis of the cryostat by an arm whose arm elements 5 which are articulated together, are arranged on pivot axes 6 which extend parallel to the longitudinal axis of the cryostat 1. The cryostat 1 preferably has also in this embodiment, in the area of the support 2, which is secured. to the arm, a sleeve 3 as it has already been described with reference to the preferred rail guidance of the cryostat 1. Such an arm is mounted in a stationary bearing 7 which, as illustrated, is arranged on the side of the cryostat, i.e. outside of the vertical which extends through the cryostat. Alternatively, the stationary bearing 7 may be arranged above and/or below the cryostat. Optionally, at least one arm extends radially relative to the arc-shaped configuration of the cryostat 1, for example, from the outer radius or from the inner radius of the arc-shaped configuration, or the apparatus has two arms in parallel planes, or in a common plane which extends V-shaped or opposite each other radially relative to the arc-shaped configuration, i.e. one arm extends from the outer radius of the arc-shaped configuration and one arm from the inner radius of the arc-shaped configuration. The pivoting axis of the stationary bearing 7 extends preferably parallel to the pivoting axes 6 of the arm elements 5, or parallel to the longitudinal axis of the cryostat 1.

FIG. 5 shows a simple embodiment of an arm with arm elements 5 in the form of a stationary hinged-on knee joint whose pivoting axes 6 are all arranged parallel to the longitudinal axis of the sleeve 3 mounted in the support 2.

FIG. 6 shows a scissor lattice formed of arm elements 5 as the arm and FIG. 7 shows parallelogram guidance formed of arm elements 5 hinged at one end stationary to a stationary bearing 7, and which have on the opposite end the support 2 in which the sleeve 3 is mounted.

The Figures make it clear that the apparatus, according to the invention, is suitable for monitoring the movement of the cryostat 1 produced by thermal contraction or expansion, thereby that the cryostat 1 is transposed essentially into a movement by means of a support 2, which is transposed by the guiding device of the apparatus essentially exclusively perpendicular to the longitudinal axis of the cryostat 1, and preferably a load or movement along the cryostat 1 is avoided or absorbed respectively. Corresponding to the preferred embodiment, the guiding device is constructed as at least one rail 4, which is essentially arranged perpendicular to the longitudinal axis of the cryostat 1, wherein a support 2 is guided longitudinally slidably on the rail 4, while the cryostat 1 is secured to the support 2, particularly secured against a displacement along its longitudinal axis on the support 2, wherein preferably a cable core, arranged in the cryostat is secured against longitudinal displacement in the area of a sleeve 3 which the cryostat is provided with in the area of the support 2, particularly secured to the sleeve 3, particularly fixed to the sleeve 3.

1. Apparatus for guiding a cryostat with a support for receiving the cryostat, wherein the support is arranged in a section of the cryostat having an arc-shaped configuration, and wherein the support is guided so as to be movable perpendicular to the longitudinal axis of the cryostat.

2. Apparatus according to claim 1, wherein the cryostat has in its inner volume a cable core with at least one conductor of superconductive material, and the cable core is secured to the ends of the cryostat.

3. Apparatus according to claim 1, wherein the cryostat has a sleeve in the section in which the cryostat is fixed to the support.

4. Apparatus according to claim 1, wherein the support is guided, at least on one rail which extends perpendicular to longitudinal axis of the cryostat.

5. Apparatus according to claim 1, wherein the support is movably guided along the rail by means of at least one wheel.

6. Apparatus according to claim 5, wherein the wheel is mounted. at the support, and the rail is stationary, or the wheel is stationary, and the rail is fixed to the support.

7. Apparatus according to claim 7, wherein the support is guided on an arm movable essentially exclusively in a plane arranged perpendicular to the longitudinal axis of the cryostat.

8. Apparatus according to claim 7, wherein the pivot axes of the arm are arranged exclusively parallel to the longitudinal axis of the cryostat.

9. Apparatus according to claim 7, wherein the arm has one or two pivoting devices arranged in parallel planes, wherein the pivoting devices are selected from the group consisting of a knee joint, a scissor lattice and a parallelogram guide.

10. Apparatus according to claim 3, wherein the cable core of the cryostat is secured in the area of the sleeve.

11. Method for cooling a superconductive cable provided with a cryostat, said method comprising the steps of
filling the inner volume of the cryostat with cooling agent, wherein the cryostat has an arc-shaped configuration at least over portions thereof, wherein the cryostat is fixed in a support in its section having the arc-shaped configuration, and wherein the support is essentially exclusively movably guided perpendicular to the longitudinal axis of the cryostat; and
upon thermal contraction or expansion, the support moves only in a guided manner perpendicular to the longitudinal axis of the cryostat.

12. Method according to claim 11, wherein the support moves along at least one rail which is arranged perpendicular to the longitudinal axis of the cryostat.

13. Method according to claim 11, wherein the support pivots along an articulated arm whose pivoting axes are arranged exclusively parallel to the longitudinal axis of the cryostat.

14. Method according to claim 11, wherein the ends of the cable core placed in the cryostat are secured stationary at the ends of the cryostat.

15. Method according to claim 14, wherein the cryostat has in the area of the support a sleeve to which the cable core placed in the cryostat is secured.
